(19) United States
(12) Patent Application Publication
(10) Pub. No.: US 2005/0205278 A1
(43) Pub. Date: Sep. 22, 2005

(54) Cable system to exchange data

(76) Inventors: Hiroyuki Maruyama, Irvine, CA (US); John Spencer, Costa Mesa, CA (US); Clas Siversten, Lilburn, GA (US); Tohru Iwama, Irvine, CA (US)

Correspondence Address: GREENBERG TRAURIG LLP, 2450 COLORADO AVENUE, SUITE 400E, SANTA MONICA, CA, 90404, US

(21) Appl. No.: 10/848,104

(22) Filed: May 17, 2004

Related U.S. Application Data
(60) Provisional application No. 60/554,797, filed on Mar. 19, 2004.

(51) Int. Cl. H01B 11/02

(52) U.S. Cl. 174/33; 174/113 R

(57) ABSTRACT

A cable system is provided that allows a computer to communicate or share data with a variety of cellular phones having different interface connectors. The cable system includes a base cable and a plurality of adapter cables. The plurality of adapter cables are adapted to communicably couple to the base cable. Each of the adapter cables is configured to communicably couple with one of the plurality of cellular phones. Depending on the cellular phone a user is using, the user may select one adapter cable from the plurality of adapter cables, which is configured to communicably couple with the user's cellular phone. The base cable is adapted to communicably couple with the computer. With the communication line linked from the PC to the base cable, from base cable to the selected adapter cable, and from the selected base cable to the user's cellular phone, the PC may exchange electronic data with the cellular phone.

### RELATED APPLICATIONS

This application claims priority to U.S. provisional application No. 60/554,797 filed Mar. 19, 2004, which is incorporated by reference.

### BACKGROUND OF THE INVENTION

1. Field of the Invention

This invention is directed to a cable system capable of interfacing data between a first electronic device and a plurality of second electronic devices having different interface connectors and electronic signaling requirements and, in particular, the cable system is capable of interfacing data between a personal computer and a plurality of cellular phones.

2. General Background and State of the Art

Cellular phones are able to recharge their batteries and exchange data through an interface connector provided with the cellular phones. Each cellular phone manufacturer, however, may utilize different interface connectors, and therefore the interface connector may be different from one manufacturer to another. That is, there is no standard with regard to the configuration of the interface connectors to interface data between the cellular phone and other electronic devices such as personal computers (PCs) and Personal Digital Assistants (PDAs). As such, to interface information between a particular cellular phone and a PC, a user needs to have a specific cable with a particular connector that is designed for that particular cellular phone to interface the information. This means that electronic retail stores such as Circuit City™ and Best Buy™ need to carry a variety of cables to meet the demands of its customers having different cellular phone connectors. Carrying a variety of cables, however, takes up valuable shelf space in the stores, which adds to the cost of selling the cables. In some instances, a number of the most popular cables are bundled into a package so that a user may pick the cable appropriate to the user's device. With the remaining cables not being used, this adds to the cost of selling the right cable to the user. Accordingly, there is still a need for interfacing data between a PC and a plurality of second electronic devices such as cellular phones with different interface connectors in a more economic way.

### INVENTION SUMMARY

This invention is directed to a cable system that allows a first electronic device to communicate with a plurality of second electronic devices having different interface connectors and electronic signaling requirements. The cable system can be used in a variety of applications. For instance, the cable system may be used to interface data between a PC and a plurality of cellular phones. The plurality of cellular phones may be manufactured by different manufacturers, and each manufacturer may use a different interface connector. The cable system includes a base cable and a plurality of adapter cables. Each of the adapter cables is configured to communicably couple with one of the plurality of cellular phones. Depending on the cellular phone a user is using, the user may select one adapter cable, from the plurality of adapter cables, which is configured to communicably couple with the user's cellular phone. The base cable has a base connector and a base interface end. The base connector of the base cable is adapted to communicably couple to a first electronic device such as a PC. Each of the plurality of adapter cables has an adapter connector and an adapter interface end. The base interface end of the base cable is configured to communicably couple with the adapter interface end of the selected adapter cable, along with adapter interface ends of other adapter cables.

To communicably couple the PC with the user's cellular phone, the base connector of the base cable is communicably coupled with the PC and the adapter connector of the selected adapter cable is communicably coupled to the user's cellular phone. With the communication line linked from the PC to the base cable, from base cable to the selected adapter cable, and from the selected adapter cable to the user's cellular phone, the PC may exchange electronic data with the cellular phone. As such, the cable system offers its users the flexibility to communicably couple a PC to a plurality of cellular phones with different interface connectors. This allows the user to communicably couple more than one phone to a PC, such as when the user upgrades to a new phone with a different interface connector or within a family where some members of the family use a different cellular phone with a different interface connector.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 illustrates a cable system including a base cable and a plurality of adapter cables configured to interface data between a personal computer and a plurality of cellular phones.

FIG. 2 is a chart illustrating each of the symbols that corresponds to a particular cellular phone.

FIG. 3 illustrates a universal serial hub and a converter provided within the base cable.

FIG. 4 illustrates an infrared attachment configured to couple with the base cable to transmit data wirelessly.

FIG. 5 illustrates a cable system including a base cable and an alternative plurality of adapters.

FIG. 6 illustrates a cable system including an alternative base cable and a plurality of adapter cables.

FIG. 7 illustrates a cable system including an intermediate cable between a base cable and a plurality of adapters to interface data between a personal computer and a plurality of cellular phones.

### DETAILED DESCRIPTION OF THE PREFERRED EMBODIMENTS

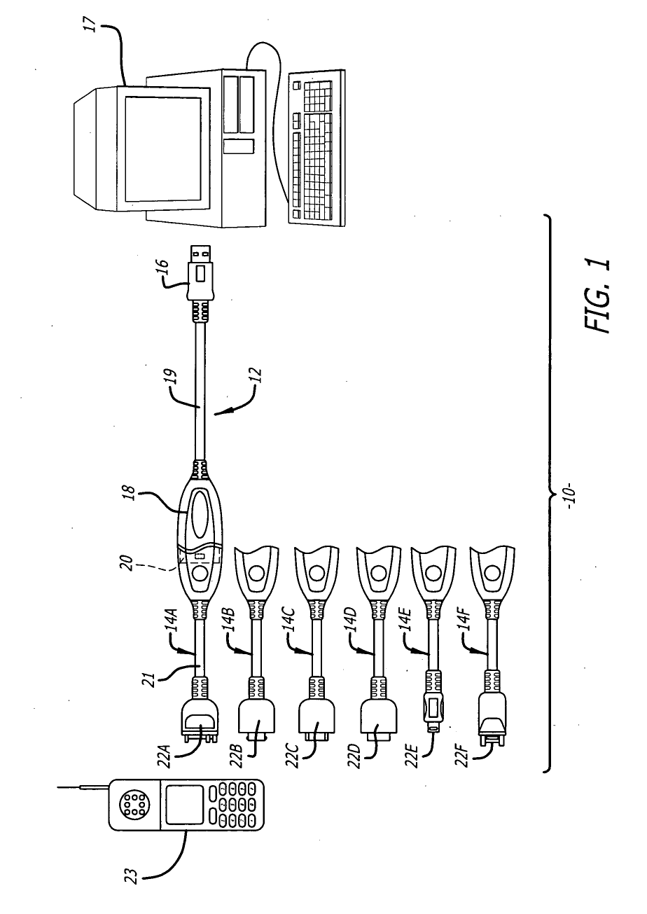

FIG. 1 illustrates a cable system 10 including a base cable 12 and a plurality of adapter cables 14A through 14F. The base cable 12 has a base connector 16 adapted to couple to a first electronic device 17. The first electronic device 17 may be a variety of electronic devices where information may be stored electronically such as a PC and PDA. The base cable 12 also has a base interface end 18 adapted to communicably couple with the plurality of adapter cables 14A through 14F. The base cable 12 includes a cable 19 between the base connector 16 and the base interface end 18 to transmit data between the two connectors 16 and 18.

Each of the plurality of adapter cables 14A through 14F has an adapter interface end 20 and a corresponding adapter connector 22. A cable 21 is provided between the adapter interface end 20 and the adapter connector 22. The adapter interface end 20 is configured to communicably couple with the base interface end 18. Each of the plurality of adapter cables 14 also has a corresponding adapter connector 22 that is configured to communicably couple to a particular cellular phone 23. For instance, the adapter connector 22A may be adapted to communicably couple to a LG™ phone; the adapter connector 22B may be adapted to communicably couple to a Nokia™ phone; the adapter connector 22C may be adapted to communicably couple to an Ericsson™ phone; the adapter connector 22D may be adapted to communicably couple to a Samsung™ phone; the adapter connector 22E may be adapted to communicably couple to a Motorola™ phone; and the adapter connector 22F may be adapted to communicably couple to a Sony™ phone. As such, with the cable system 10, one base cable 12 may be provided with a plurality of adapter cables so that a PC may share data with a variety of different types of cellular phones with different data interface connectors. That is, the user may select a particular adapter cable corresponding to the type of cellular phone the user is using then couple the base interface end 18 to the adapter interface end 20 to exchange data between the first electronic device and the desired cellular phone.

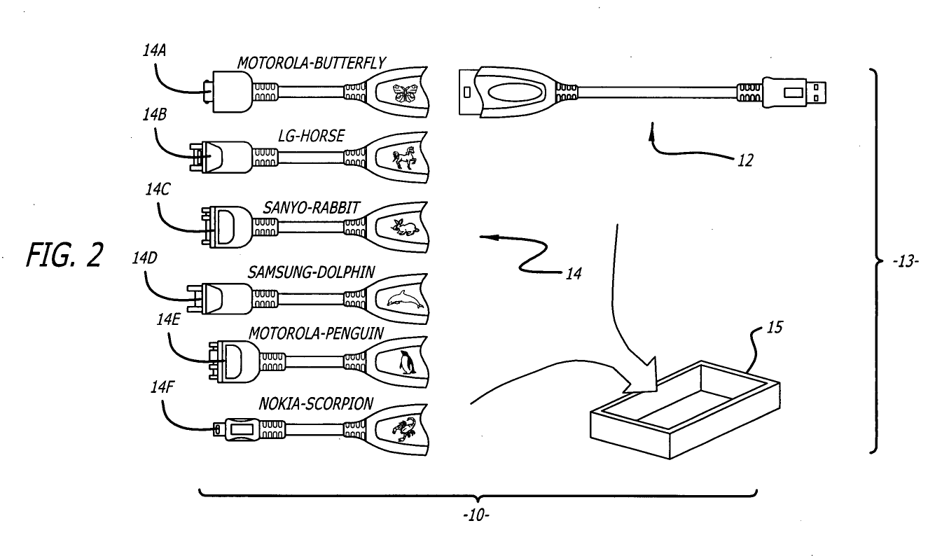

FIG. 2 further illustrates that each of the base cables 14A through 14F may be provided with a symbol on its adapter interface end 20. The symbol on the adapter interface end may correspond to a particular cellular phone manufacturer. For instance, a butterfly symbol may correspond to a certain types of Motorola cellular phones; a horse symbol may correspond to LG cellular phones; a rabbit symbol may correspond to Sanyo cellular phones; a dolphin symbol may correspond to Samsung cellular phones; a penguin symbol may correspond to a particular type of Motorola cellular phones; and a scorpion symbol may correspond to Nokia cellular phones.

As illustrated in FIG. 2, a chart may be provided with a list of the symbols and different types of cellular phones that may be used corresponding to each of the symbols. This way, a user may review the chart and find a symbol that corresponds to the cellular phone the user is using. Based on the symbol, the user may select the right adapter cable to communicably couple with the base cable 12 to exchange data between the PC and the user's cellular phone. In this regard, a cable kit 13 may be provided in a container 15 with a base cable 12, a plurality of adapter cables 14A through 14F, and a table with a list of symbols to indicate to a user the symbol that corresponds to a particular cellular phone the user is using.

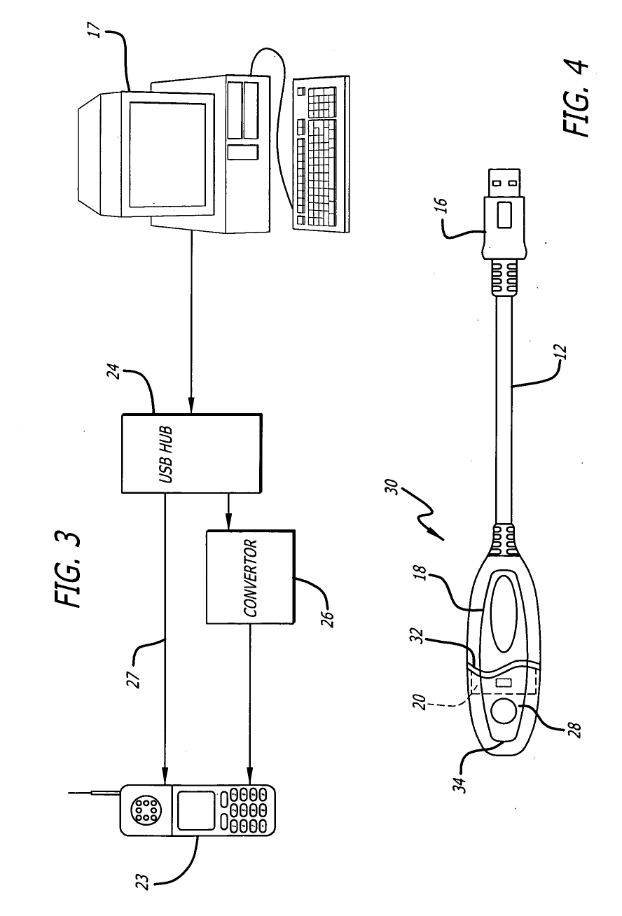

FIG. 3 illustrates that a Universal Serial Bus (USB) hub 24 and a converter 26 may be provided within the cable system 10. By way of background, some cellular phones may be provided with a Code-Division Multiple Access (CDMA) chip with a USB output. Most, if not all, PCs are provided with a USB port for exchanging data so that cellular phones with a CDMA chip and a USB port can communicate directly with a PC. Many cellular phones, however, are not provided with a CDMA chip, so that direct USB serial communication between the cellular phones without a CDMA and a PC is not possible. To accommodate cellular phones with and without the CDMA chip, the universal cable system 10 may be provided with the USB hub 24 and the converter 26. If the cellular phone is able to directly receive the USB output from a PC, the USB hub 24 provides a direct interface 27 between the PC and the cellular phone. On the other hand, if the cellular phone is unable to directly receive the USB output, the USB hub 24 sends the signal from the PC to the serial converter 26, which sends a serial signal to the cellular phone. The circuitry for the USB hub 24 and the converter 26 may be provided within the base interface 18 so that the same circuitry can be used with the variety of adapter cables to minimize the cost of the universal cable system 10. The cable system may connect cellular phones to PCs via its USB interface port in order to send and receive or back up data. The cable system may allow the PC to connect to the internet by using the cellular phone as a modem. The cable system 10 allows users to connect to more than one type of cellular phone, such as during upgrading of phones or shared usage within the family.

FIG. 4 illustrates a cable system 30 including a base cable 12, as discussed above, adapted to communicably couple with an IrDa (infrared) attachment 28. The base connector 16 of the base cable 12 is adapted to communicably couple to the USB port of the PC 17. The IrDa attachment 28 has an interface side 32 and a transceiver 34. The interface side 32 of the attachment 28 is adapted to communicably couple with the base interface end 18 of the base cable 12. The transceiver 34 is capable of transmitting the data provided through the base cable 12 wirelessly to a second electronic device such as a cellular phone. That is, the IrDa attachment 28 sends the data from the PC 17 wirelessly through infrared signals. A second electronic device, such as a cellular phone, with an infrared port may then receive the infrared signals to exchange the data wirelessly with the PC.

Some PCs are not equipped with a port such as an infrared port and/or Bluetooth port to allow the PCs to communicate wirelessly with other electronic devices. In such instances, the cable system 30 may be used to wirelessly couple a PC, without a wireless communication port, with a variety of cellular phones. The base connector 16 of the base cable 12 may be connected to the USB port of the PC. On the opposite end, the interface side 32 of the attachment 28 is coupled to the base interface end 18 of the base cable 12. With such communication links, the base cable 12 is able to provide the data from the USB port of the PC to the attachment 28 to transmit the data wirelessly to a second electronic device such as a cellular phone that has an infrared port or a Bluetooth port to receive the data provided through the USB port of the PC. Conversely, the attachment 28 may receive data transmitted from the infrared port or Bluetooth port of the cellular phone 17. This way, a PC that does not have a port to receive wireless data may exchange data wirelessly with a cellular phone.

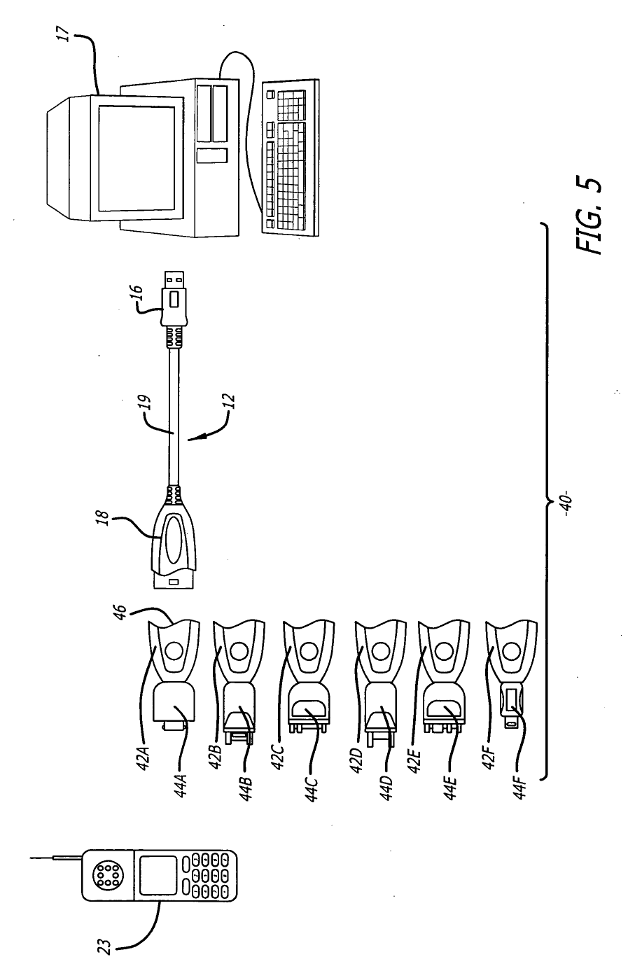

FIG. 5 illustrates a cable system 40 including a base cable 12, as discussed above, and a plurality of adapters 42A through 42F. Each of the adapters 42 has an interface end 46 that is substantially similar to the adapter interface end 20, as discussed above, to allow the interface end 46 to communicably couple to the base interface end 18. Each of the plurality of the adapters 42A through 42F has a connecting end 44A through 44F, respectively. Each connecting end is configured to communicably couple with a particular cellular phone. Note that the adapters 42A-42F do not have a cable between the connecting end 44 and the interface end 46. The base cable 12, however, is provided with the cable 19 to allow the base cable 12 to extend between the PC 17 and the cellular phone 23. One of the adapters 42A through 42F may be used to communicably couple the base cable 12 with a particular cellular phone. For example, the connecting end 44A may communicably couple to an LG™ phone; the connecting end 44B may communicably couple to a Nokia™ phone; the connecting end 44C may communicably couple to an Ericsson™ phone; the connecting end 44D may communicably couple to a Samsung™ phone; the connecting end 44E may communicably couple to a Motorola™ phone; and the connecting end 44F may communicably couple to a Sony™ phone. To exchange data between the PC 17 and a Nokia™ phone, for example, a user may communicably couple the connecting end 44B of the adapter 42B to the Nokia™ phone. The base connector 16 of the base cable 12 is then communicably coupled to the PC 12 and the base interface end 18 is communicably coupled to the interface end 46 of the adapter 42. With the cable system 40 communicably coupling the PC 17 to the Nokia™ phone, data may be exchanged between the two electronic devices 17 and 23.

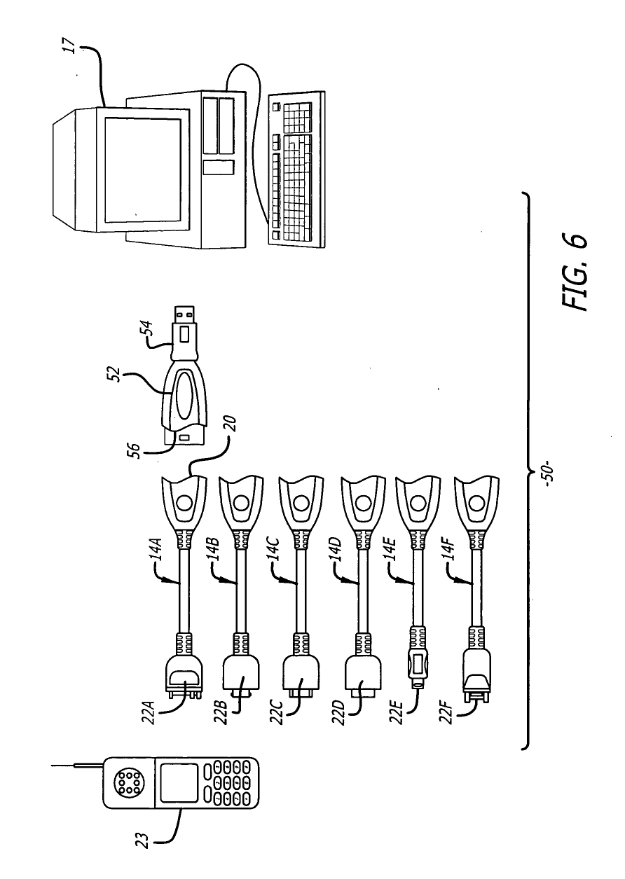

FIG. 6 illustrates a cable system 50 including a base 52 and a plurality of adapter cables 14A through 14F. The plurality of adapter cables 14A through 14F are substantially similar to the adapter cables discussed above in reference to FIG. 1. The base 52 has a base connector 54 and a base interface end 56 that are substantially similar to the base connector 16 and the base interface end 18, respectively. The base 52, however, may not include a cable between the two connectors 16 and 18. As discussed above with regard to FIG. 1, the base connector 16 is adapted to communicable couple to the PC 17 and the base interface end 18 is configured to communicably couple to the adapter interface end 20 of the adapter cable. The USB hub 24 and the converter 26 discussed above in reference to FIG. 3 may be incorporated into the base 52. Accordingly, the cable system 50 may be used to communicably couple a PC with a plurality of cellular phones to allow the PC to exchange data with any one of the plurality of cellular phones.

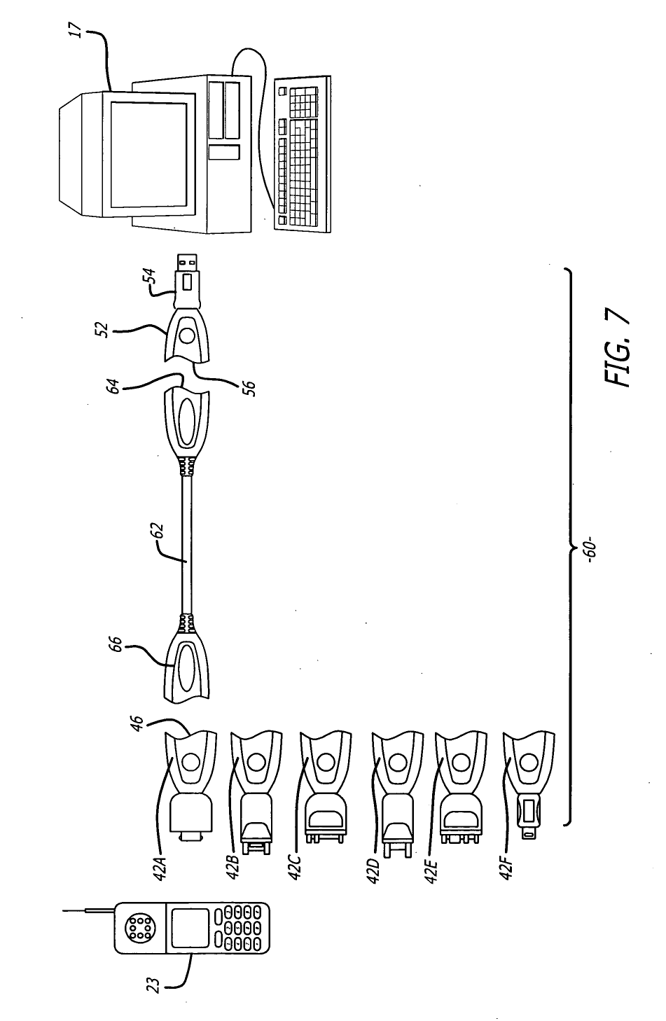

FIG. 7 illustrates a cable system 60 including an intermediate cable 62 configured to communicably couple in between a base adapter 52 and a plurality of adapters 42A through 42F. The plurality of adapters 42A through 42F and the base adapter 52 are substantially similar to the ones described in FIGS. 5 and 6 above, respectively. The intermediate cable 62 has a first interface end 64 and a second interface end 66 configured to communicably couple to the base adapter 52 and the plurality of adapters 42A through 42F, respectively. A user may select one adapter from the plurality of adapters 42A through 42F that is configured to communicably couple with the user's cellular phone. The second end 66 of the intermediate cable 62 may be coupled to the interface end 46 of the selected adapter and the first end 64 of the intermediate cable 62 may be coupled to the base interface end 56 of the base adapter 52. With the cable system 60 assembled, the base connector 54 may be communicably coupled to the PC 17 to allow the PC 17 to exchange data with the cellular phone. In addition, the base connector end 54 may be adapted to communicably couple to a variety of first electronic devices other than the PC 17, such as PDA and IPod™.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A cable system capable of interfacing data between a first electronic device and a plurality of second electronic devices, the plurality of second electronic devices having different data communication connectors, the system comprising:
a base cable having a base connector and a base interface end, the base connector configured to communicably couple to the first electronic device; and
a plurality of adapter cables, each of the plurality of adapter cables having an adapter connector and an adapter interface end, the adapter connector for each of the plurality of adapter cables configured to communicably couple with a corresponding data communication connector provided in the plurality of second electronic devices, and the base interface end configured to communicably couple with the adapter interface end of the plurality of adapter cables.

2. The cable system according to claim 1, where the first electronic device is a computer and the plurality of the second electronic devices are cellular phones from different manufacturers.

3. The cable system according to claim 2, further including a Universal Serial Bus (USB) hub and a USB converter, where the USB hub sends signals from the computer to the USB converter to allow a cellular phone to receive the signals from the computer.

4. The cable system according to claim 1, where each of the plurality of adapter cables is provided with a different symbol to associate each of the plurality of adapter cables with the corresponding data communication connector provided in the plurality of second electronic devices.

5. The cable system according to claim 1, including a wireless attachment adapted to communicably couple with the base interface end to transmit signals from the first electronic device to one of the plurality of the second electronic devices wirelessly.

6. A cable system capable of interfacing data between a first electronic device and a plurality of second electronic devices, the plurality of second electronic devices having different data communication connectors, the system comprising:
a base cable having a base connector, the base connector adapted to communicably couple to the first electronic device; and
a plurality of adapter cables, each of the plurality of adapter cables having a different adapter connector adapted to communicably couple to a corresponding data communication connector provided with one of the plurality of second electronic devices, the base cable adapted to communicably couple with the plurality of adapter cables to allow the first electronic device to communicably couple with any one of the plurality of second electronic devices.

7. The cable system according to claim 6, where the base cable has a base interface end on the opposite end of the base connector and each of the plurality of adapter cables has an adapter interface end on the opposite end of the different adapter connector, the base interface end adapted to communicably couple with the adapter interface end to communicably couple the base cable with any one of the plurality of adapter cables.

8. The cable system according to claim 6, where the first electronic device is a computer and the plurality of the second electronic devices are cellular phones from different manufacturers.

9. The cable system according to claim 8, further including a universal serial bus (USB) hub and a USB converter, where the USB hub sends signals from the computer to the USB converter to allow a cellular phone to receive the signals from the computer.

10. The cable system according to claim 6, where each of the plurality of adapter cables is provided with a different symbol to associate each of the plurality of adapter cables with the corresponding data communication connector provided in the plurality of second electronic devices.

11. The cable system according to claim 6, including a wireless attachment adapted to communicably couple with the base interface end to transmit data from the first electronic device to one of the plurality of the second electronic devices wirelessly.

12. A cable system capable of interfacing data between a first electronic device and a plurality of second electronic devices with different data communication connections, the system comprising:
a base cable having a base connector configured to communicably couple with the first electronic device; and
a plurality of adapters, each adapter having a different adapter connector adapted to communicably couple with a corresponding data communication connection provided in the plurality of second electronic devices, the base cable adapted to communicably couple with each of the plurality of to allow the first electronic device to interface data with any one of the plurality of second electronic devices.

13. The cable system according to claim 12, where the base cable has a base interface end on the opposite end of the base connector and each of the plurality of adapters has an adapter interface end on the opposite end of the different adapter connector, the base interface end adapted to communicably couple with the adapter interface end to communicably couple the base cable with any one of the plurality of adapter cables.

14. The cable system according to claim 12, where each of the plurality of adapters has a cable between the different adapter connectors and the adapter interface end.

15. A cable system capable of interfacing data between a computer and a plurality of cellular phones with different data communication connections, the system comprising:
a plurality of adapters, each adapter having a different adapter connector adapted to communicably couple with a corresponding data communication connection provided in the plurality of cellular phones; and
a base having a base connector and a base interface end, the base connector adapted to communicably couple to the computer and the base interface end adapted to communicably couple with any one of the plurality of adapters.

16. The cable system according to claim 15, where the each of the plurality of adapters has an adapter interface end on the opposite end of the different adapter connector, the base interface end adapted to communicably couple with the adapter interface end to communicably couple the base cable with any one of the plurality of adapter cables.

17. The cable system according to claim 16, where each of the plurality of adapters include a cable between the different adapter connector and the adapter interface end.

18. The cable system according to claim 16, where base includes a cable between the base connector and the base interface end.

19. A cable system kit capable of interfacing data between a computer and a plurality of cellular phones with different data communication connections, the kit comprising:
a plurality of adapters, each adapter having a different adapter connector adapted to communicably couple with a corresponding data communication connection provided in the plurality of cellular phones;
a base having a base connector and a base interface end, the base connector adapted to communicably couple to the computer and the base interface end adapted to communicably couple with any one of the plurality of adapters; and
a container adapted to house the plurality of adapters and the base.

20. The kit according to claim 19, where the each of the plurality of adapters has an adapter interface end on the opposite end of the different adapter connector, the base interface end adapted to communicably couple with the adapter interface end to communicably couple the base cable with any one of the plurality of adapter cables.

21. The kit according to claim 20, where each of the plurality of adapters include a cable between the different adapter connector and the adapter interface end.

22. The kit according to claim 20, where base includes a cable between the base connector and the base interface end.

23. The kit according to claim 19, where each of the plurality of adapters is provided with a different symbol to associate each of the plurality of adapters with the corresponding data communication connector provided in the plurality of second electronic devices.

24. The kit according to claim 19, including a tale with a list of the symbols provided on the plurality of adapters with corresponding cellular phones associated with the symbols.

25. A cable system capable of interfacing data between a computer and a plurality of cellular phones with different data communication connections, the system comprising:
a base cable having a base connector configured to communicably couple with the computer; and
means for communicably coupling the base cable with any one of the plurality of cellular phones to allow the computer to send data to any one of the plurality of cellular phones.

26. The cable system according to claim 25, where the means for communicably coupling is a plurality of adapters, each adapter having a different adapter connector adapted to communicably couple with a corresponding data communication connection provided in the plurality of cellular phones, and each adapter further having an adapter interface end adapted to communicably couple with the base cable.

27. The cable system according to claim 25, the base cable having a base interface end on the opposite end of the base connector, where the means for communicably coupling is a wireless attachment adapted to communicably couple with the base interface end to transit signals from the computer wirelessly to any one of the plurality of cellular phones.

28. A method for interfacing data between a first electronic device and a plurality of second electronic devices each with different connections, the system comprising:
dividing a cable system into at least two portions, a base cable portion and an adapter cable portion;
configuring one end of the base cable portion to communicably couple with the first electronic device;
configuring one end of each of the plurality of the adapter cable portions to communicably couple with a corresponding data communication connector provided in the plurality of second electronic devices; and
configuring opposing end of each of the plurality of the adapter portions to communicably couple with the base cable portion to allow the first electronic device to communicate with any one of the plurality of second electronic devices.

29. The method according to claim 28, including converting electronic signals from the first electronic device to converted signals, if needed, to allow any one of the plurality of second electronic devices to communicate with the first electronic device.

30. The method according to claim 28, where the first electronic device is a computer and the plurality of the second electronic devices are cellular phones from different manufacturers.

31. The method according to claim 28, marking the plurality of adapter cables with a different symbol to associate each of the plurality of adapter cables with the corresponding data communication connector provided in the plurality of second electronic devices.
